(19) United States
(12) Patent Application Publication
(10) Pub. No.: US 2004/0105051 A1
(43) Pub. Date: Jun. 3, 2004

(54) [WIDE VIEWING ANGLE LCD AND METHOD OF MANUFACTURING THE SAME]

(76) Inventors: Li-Sen Chuang, Penghu (TW); Kuang-Lung Kuo, Taipei (TW); Dai-Liang Ting, Hsinchu (TW); Sheng-Shiou Yeh, Miaoli (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,682

(22) Filed: Oct. 17, 2003

(30) Foreign Application Priority Data
Oct. 17, 2002 (TW) 91123915

(51) Int. Cl. G02F 1/1335; G02F 1/1343

(52) U.S. Cl. 349/106; 349/141

(57) ABSTRACT

A wide viewing angle liquid crystal display and method of manufacturing the same. A color filter layer is formed above a substrate having thin film transistors. Pixel electrodes and common electrodes are formed above the color filter layer. Since no thick color filter layer is formed between a liquid crystal layer and the pixel electrodes/common electrodes, driving voltage for the liquid crystal display is lowered and the quantity of trapped electric charges is reduced.

### CROSS REFERENCE TO RELATED APPLICATIONS

This application claims the priority benefit of Taiwan application serial no. 91123915, filed Oct. 17, 2002.

### BACKGROUND OF INVENTION

1. Field of Invention

The present invention relates to a liquid crystal display (LCD) and method of manufacturing the same. More particularly, the present invention relates to a wide viewing angle (WVA) liquid crystal display and method of manufacturing the same.

2. Description of Related Art

Liquid crystal display (LCD) is a light and compact device driven by a low voltage that produces a high picture quality without consuming too much power. Due to these advantages, LCD has been deployed in a number of electrical appliances including portable televisions, mobile phones, camcorders, notebook computers, desktop computers, projection televisions and so on. In fact, LCD is gradually replacing the bulky and radiation prone cathode ray tube (CRT) to become the mainstream display. However, LCD is still disadvantaged by narrow viewing angle and high price. Consequently, innovation capable of increasing the viewing angle is a major research topic. At present, a number of methods for increasing the viewing angle of an LCD have been suggested including the in-plane switching (IPS) LCD and the fringe field switching (FFS) LCD.

In addition, the technique of fabricating a colorfilter layer over a thin film transistor array (color filter on array, COA) is widely adopted in many LCD products and reference materials can be found in U.S. Pat. No. 6,031,512. However, in the conventional method of applying the COA technique to a wide viewing angle LCD, the color filter layer is formed over the pixel electrodes and the common electrodes after the pixel electrodes and the common electrodes are fabricated.

FIG. 1 is a cross-sectional view of a portion of the pixel region in a wide viewing angle LCD fabricated using the conventional COA technique. In FIG. 1, the structure of only a portion of the pixel region of the liquid crystal display is shown. To produce a conventional wide viewing angle LCD, a first substrate 10 having a thin film transistor 11 is provided. The thin film transistor 11 further includes a gate electrode 12, a gate insulating layer 14, a channel layer 16 and source/drain regions 18a/18b. A passivation layer 20 is formed over the thin film transistor 11.

Thereafter, an opening (not shown) that exposes the drain region 18b is formed in the passivation layer 20. A pixel electrode 22 and a common electrode 24 are formed on the surface of the passivation layer 20. In the meantime, electrode material is deposited to fill the opening, forming a conductive structure 21. The pixel electrode 22 and the common electrode 24 are alternately positioned and the pixel electrode 22 and the drain region 18b are electrically connected through the conductive structure 21. In addition, the common electrodes 24 and other common electrodes on the pixel region are serially connected such that all receive an identical potential.

A color filter layer 26 is formed over the passivation layer 20 covering the pixel electrode 22 and the common electrode 24. Thereafter, a first alignment film 28 is formed over the color filter layer 26.

A second substrate 34 is provided and then a second alignment film 32 is formed over the second substrate 34. Using frame plastic (not shown), the second substrate 34 is fixed on top surface of the first substrate 10 with the second alignment film 32 facing the first alignment film 28. Liquid crystal is injected into the space between the first alignment layer 28 on the first substrate 10 and the second alignment layer 32 on the second substrate 34 to form a liquid crystal layer 30. Thus, a liquid crystal display is formed.

However, the color filter layer of conventional wide viewing angle LCD is formed over the pixel electrode and the common electrode. Due to the presence of a thick color filter layer between the electrodes (including the pixel electrode and the common electrode) and the liquid crystal layer, voltage for driving the LCD will increase. Moreover, by forming a relatively thick layer of organic color filter layer over the electrodes, including the pixel electrode and the common electrode, residual charges are often retained leading to a deterioration of the picture quality in the LCD.

### SUMMARY OF INVENTION

Accordingly, one object of the present invention is to provide a wide viewing angle liquid crystal display and method of manufacturing the same that requires a lower driving voltage.

A second object of the invention is to provide a wide angle viewing liquid crystal display and method of manufacturing the same that produces a better image quality and provides a higher reliability.

To achieve these and other advantages and in accordance with the purpose of the invention, as embodied and broadly described herein, the invention provides a wide viewing angle (WVA) liquid crystal device (LCD). The WVA LCD includes a first substrate, a color filter layer, a plurality of pixel electrodes, a common electrode, a first alignment film, a second substrate, a second alignment film and a liquid crystal layer. The first substrate includes a plurality of thin film transistors, a plurality of scanning lines and a plurality of data lines. Each thin film transistor has a gate electrode, a gate insulatinglayer, a channel layer and a source/drain regions. The color filter layer is formed over the first substrate covering the thin film transistor, the scanning lines and the data lines. The pixel electrodes are formed over parts of the color filter layer. Each pixel electrode and the drain region of a corresponding thin film transistor are electrically connected through a conductive structure in the color filter layer. The common electrodesare formed over parts of the color filter layer. The common electrodes and the pixel electrodes are alternately positioned. The common electrodes in each pixel region are serially connected together to receive an identical potential. In addition, the common electrodes of this invention may be formed over the color filter layer above the data lines for increasing the aperture ratio of the liquid crystal display. The first alignment film is formed over the color filter layer covering the pixel electrodes and the common electrodes. Furthermore, the second substrate is formed over the first substrate. The second alignment film is formed over the second substrate such that the second alignment film faces the first alignment film. The liquid crystal layer is formed between the fist alignment film and the second alignment film. A planarization layer may also be selectively formed over the color filter layer.

This invention also provides an alternative wide viewing angle liquid crystal display having a first substrate, a color filter layer, a plurality of pixel electrodes, a dielectric layer, a plurality of common electrodes, a first alignment film, a second substrate, a second alignment film and a liquid crystal layer. The first substrate contains a plurality of thin film transistors, a plurality of scanning lines and a plurality of data lines. Each thin film transistor has a gate electrode, a gate insulating layer, a channel layer and a source/drain regions. The color filter layer is formed above the first substrate covering the thin film transistors, the scanning lines and the data lines. The pixel electrodesare formed overparts of the color filter layer. Each pixel electrode and the drain region of a corresponding thin film transistor are electrically connected through a conductive structure in the color filter layer. The dielectric layer is formed over the color filter layer covering the pixel electrodes. In addition, the common electrodes are formed over parts of the dielectric layer. The common electrodes and the pixel electrodes are alternately positioned. The common electrode in each pixel region is serially connected to receive the same potential. Furthermore, the common electrodes may also be formed on the color filter layer above the data line so that the aperture ratio of the LCD is increased. The pixel electrodes, the dielectric layer and the common electrodes together form a plurality of pixel storage capacitor structures. The first alignment film is formed over the dielectric layer covering the common electrode. The second substrate is formed over the first substrate. The second alignment film is formed over the second substrate such that the second alignment film faces the first alignment film. The liquid crystal layer is formed between the first alignment film and the second alignment film. A planarization layer may also be selectively formed over the color filter layer.

This invention also provides a method of manufacturing a wide viewing angle liquid crystal display. A first substrate having a plurality of thin film transistors, a plurality of scanning lines and a plurality of data lines thereon is provided. Each thin film transistor has a gate electrode, a gate insulating layer, a channel layer and a pair of source/drain regions. A color filter layer is formed over the first substrate covering the thin film transistors, the scanning lines and the data lines. In this invention, a planarization layer may also be formed over the color filter layer selectively. A plurality of openings each exposing the drain region of a corresponding thin film transistor is formed in the color filter layer. Thereafter, a plurality of pixel electrodes and a plurality of common electrodes are formed over the color filter layer. In the meantime, a conductive structure is formed in each opening. The common electrodes and the pixel electrodes are alternately positioned and the pixel electrode and the drain region of a corresponding thin film transistor are electrically connected through the conductive structure. The common electrode in each pixel region is serially connected to receive the same potential. Note that the common electrodes may also form over the color filter layer above the data lines so that the aperture ratio of the LCD is increased. Thereafter, a first alignment film is formed over the color filter layer covering the pixel electrodes and the common electrode. A second substrate is then provided. A second alignment film is formed over the second substrate. The second substrate is formed over the first substrate such that the second alignment film faces the first alignment film. Finally, liquid crystal is injected into the space between the first alignment film on the first substrate and the second alignment film on the second substrate.

This invention also provides an alternative method of manufacturing a wide viewing angle liquid crystal display. A first substrate having a plurality of thin film transistors, a plurality of scanning lines and a plurality of data lines thereon is provided. Each thin film transistor has a gate electrode, a gate insulating layer, a channel layer and a source/drain regions. A color filter layer is formed over the first substrate covering the thin film transistors, the scanning lines and the data lines. In this invention, a planarization layer may also be formed over the color filter layer selectively. A plurality of openings each exposing the drain region of a corresponding thin film transistor is formed in the color filter layer. Thereafter, a plurality of pixel electrodes are formed over the color filter layer. In the meantime, a conductive structure is formed in each opening. The pixel electrode and the drain region of a corresponding thin film transistor are electrically connected through the conductive structure. A dielectric layer is formed over the color filter layer covering the pixel electrodes. A plurality of common electrodesare formed over the dielectric layer. The common electrodes and the pixel electrodes are alternately positioned and the common electrode in each pixel region is serially connected to receive the same potential. Note that the common electrodes may also form over the color filter layer above the data lines so that the aperture ratio of the LCD is increased. The pixel electrodes, the common electrodes and the dielectric layer between the pixel electrodes and the common electrodes together form a plurality of pixel storage capacitor structures. Thereafter, a first alignment film is formed over the dielectric layer covering the common electrodes. A second substrate is then provided. A second alignment film is formed the second substrate. The second substrate is formed over the first substrate such that the second alignment film faces the first alignment film. Finally, liquid crystal is injected into the space between the first alignment film on the first substrate and the second alignment film on the second substrate.

In this invention, the color filter layer is formed underneath the pixel electrode and the common electrode. In other words, no thick color filter layer exists between the liquid crystal layer and the pixel electrode/common electrode. Hence, the required driving voltage for the wide viewing angle LCD is lowered.

In addition, without any organic color filter layer above the pixel electrodes and the common electrodes, no residual electric charges are trapped. Hence, quality of the wide viewing angle LCD is improved.

Moreover, the pixel electrodes may also be positioned over the scanning lines. Hence, aperture ratio of the LCD are increased.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a portion of the pixel region in a wide viewing angle LCD fabricated using the conventional COA technique.

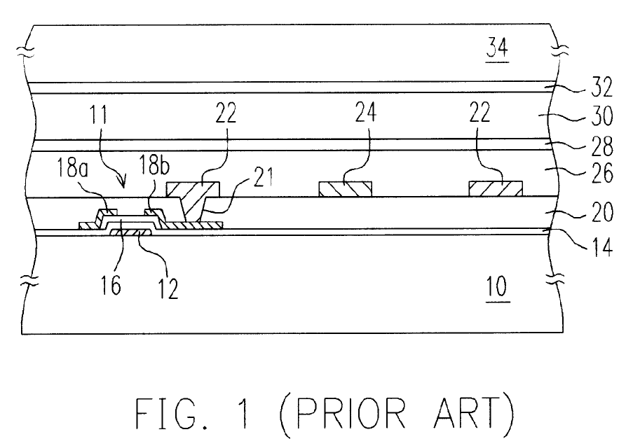

FIG. 2 is a top view showing the substrate having thin film transistors thereon of a wide viewing angle liquid crystal display according to one preferred embodiment of this invention.

FIG. 3 is a cross-sectional view of one of the pixel regions in an IPS wide viewing angle LCD fabricated using the COA technique according to one preferred embodiment of this invention.

FIG. 4 is a cross-sectional view of one of the pixel regions in an IPS wide viewing angle LCD fabricated using the COA technique according to a second preferred embodiment of this invention.

FIG. 5 is a cross-sectional view of one of the pixel regions in a FFS wide viewing angle LCD fabricated using the COA technique according to one preferred embodiment of this invention.

FIG. 6 is a cross-sectional view of one of the pixel regions in a FFS wide viewing angle LCD fabricated using the COA technique according to a second preferred embodiment of this invention.

FIG. 7 is a top view showing the substrate having thin film transistors thereon of a wide viewing angle liquid crystal display according to a second preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

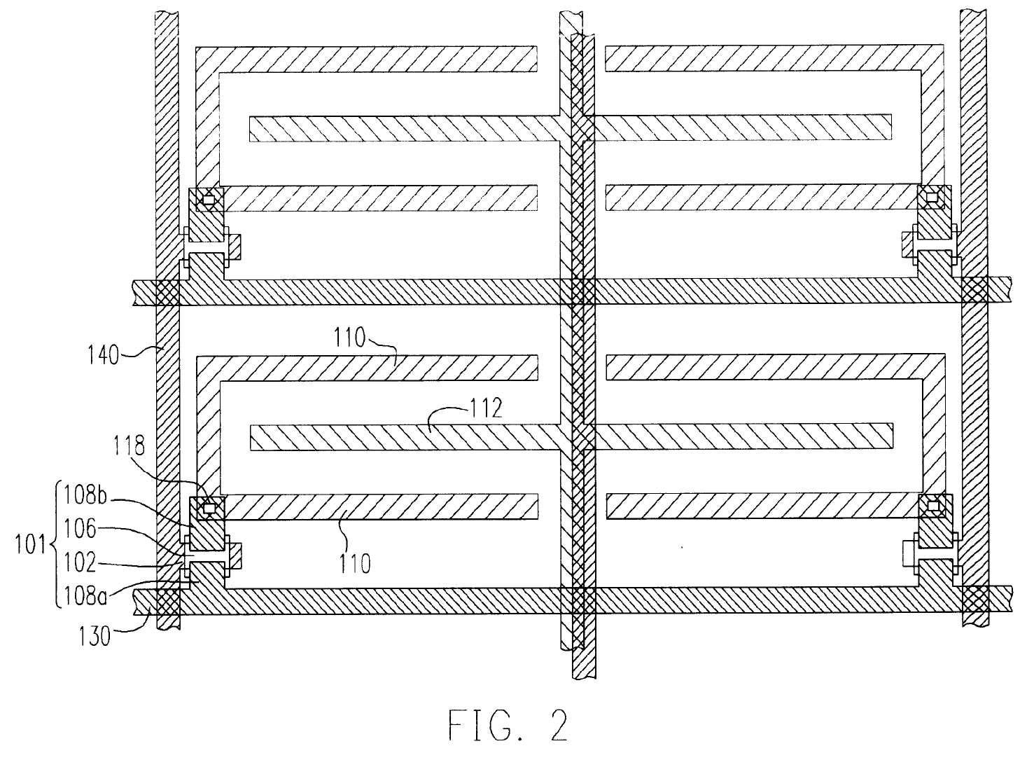

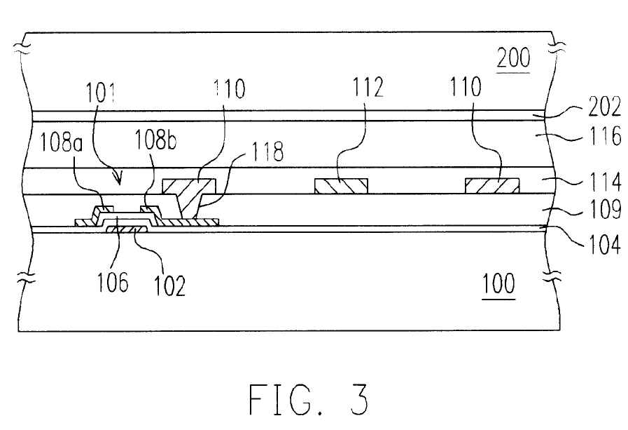

FIG. 2 is a top view showing the substrate having thin film transistors thereon of a wide viewing angle liquid crystal display according to one preferred embodiment of this invention. FIG. 3 is a cross-sectional view of one of the pixel regions in an IPS wide viewing angle LCD fabricated using the COA technique according to one preferred embodiment of this invention. To fabricate the wide viewing angle liquid crystal display, a first substrate 100 having a plurality of thin film transistors 101, a plurality of scanning lines 140 and a plurality of data lines 130 thereon is provided.

To form the thin film transistors 101, the scanning lines 140 and the data lines 130 over the first substrate 100, gate electrodes 102 and scanning lines 140 connected to the gate electrode 102 are formed over the first substrate 100. Thereafter, an insulating material is deposited over the first substrate 100 to form a gate insulating layer 104 covering the gate electrodes 102 and the scanning lines 140. A channel layer 106 is formed over the gate insulating layer 104 above the gate electrode 102. A source/drain regions 108a/108b is formed over the channel layer 106. In the meantime, data lines 130 having connection with the respective source region 108a are formed over the gate insulating layer 104.

A color filter layer 109 is formed over the first substrate 100 covering the thin film transistors 101, the scanning lines 140 and the data lines 130. The color filter layer comprises a plurality of red filter blocks, a plurality of green filter blocks and a plurality of blue filter blocks (R, G, B) specifically arranged together to form groups. In this embodiment, the red (R), the green (G) and the blue (B) are arranged, for example, in mosaic type, triangle type, stripe type or four-pixel (RGGB) type. In addition, the network-like space between the R, G, B blocks is occupied by a black matrix (BM) layer.

A plurality of openings (not shown) that exposes the drain region 108b of the thin film transistors is formed in the color filter layer 109. A plurality of pixel electrodes 110 and a common electrode 112 are formed over the color filter layer 109. In the meantime, electrode material is deposited into the openings to form a plurality of conductive structures 118. Each pixel electrode 110 is electrically connected to the drain region 108b of a corresponding thin film transistor 101 through the conductive structure 118. The common electrode 112 in each pixel region is serially linked to receive the same potential so that the common electrodes in all pixel regions are connected together. Moreover, the pixel electrode 110 and the common electrode 112 in each pixel region are alternately positioned (as shown in FIG. 2). In addition, the method of forming the pixel electrodes 110, the common electrodes 112 and the conductive structures 118 may include the following steps. First, an electrode material is deposited over the color filter layer 109 filling the openings to form an electrode layer. Thereafter, the electrode layer is patterned to form the pixel electrodes 110 and the common electrodes 112 so that the conductive structure 118 is also formed after the patterning process. The pixel electrodes 110 and the common electrodes 112 are fabricated using, for example, a metallic material or an indium-tin-oxide (ITO) material.

A first alignment film 114 is formed over the color filter layer 109 covering the pixel electrodes 110 and the common electrodes 112. The first alignment film 114 is a layer of material that aligns the subsequently deposited liquid crystal molecules in a designated direction.

Thereafter, as shown in FIG. 3, a second substrate 200 is provided. A second alignment film 202 is formed over the second substrate 200. Using a frame plastic (not shown), the second substrate 200 is formed over the first substrate 100 such that the second alignment film 202 on the second substrate 200 faces the first alignment film 114 on the first substrate 100. Liquid crystal is injected into the space between the first alignment film 114 on the first substrate 100 and the second alignment film 202 on the second substrate 200 to form a crystal layer 116. Ultimately, a liquid crystal display is produced.

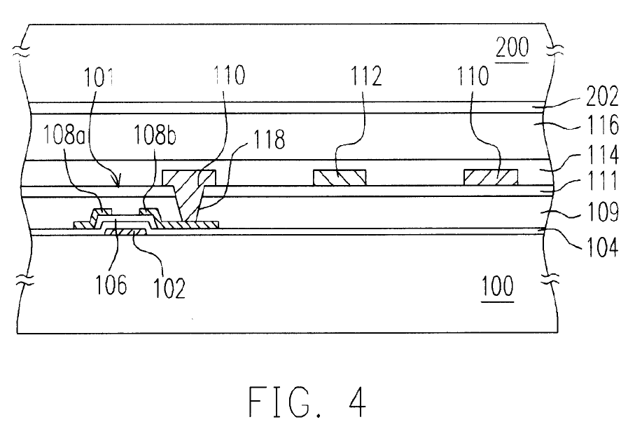

A planarization layer 111 (as shown in FIG. 4) may also be formed over the color filter layer 109. Since the surface between the R, G, B color regions and the black matrix layer in the color filter layer 109 is often uneven, the planarization layer 111 smoothes out the color filter layer 109.

This invention also provides a wide viewing angle LCD comprising a first substrate 100, a color filter layer 109, a plurality of pixel electrodes 110, a common electrode 112, a first alignment film 114, a second substrate 200, a second alignment film 202 and a liquid crystal layer 116. The surface of the first substrate 100 has a plurality of thin film transistors 101, a plurality of scanning lines 140 and a plurality of data lines 130. Each thin film transistor 101 has a gate electrode 102, a gate insulating layer 104, a channel layer 106 and a source/drain regions 108a/108b. The color filter layer 109 is formed over the first substrate 100 covering the thin film transistor 101, the scanning lines 140 and the data lines 130. The pixel electrodes 110 and the common electrodes 112 are formed over parts of the color filter layer 109. The common electrode 112 and the pixel electrode 110 are alternately positioned. Each pixel electrode 110 and the drain region 108b of a corresponding thin film transistor 101 are electrically connected through a conductive structure 118 in the color filter layer 109. The common electrodes 112 in each pixel region are serially connected together to receive an identical potential. The first alignment film 114 is formed over the color filter layer 109 covering the pixel electrodes 110 and the common electrodes 112. Furthermore, the second substrate 200 is formed over the first substrate 100. The second alignment film 202 is formed over the surface of the second substrate 200 such that the second alignment film 202 faces the first alignment film 114 on the first substrate 100. The liquid crystal layer 116 is formed between the fist alignment film 114 and the second alignment film 202. A planarization layer 111 may also be selectively formed over the surface of the color filter layer 109.

In this invention, the color filter layer 109 is formed underneath the pixel electrodes 110 and the common electrode 112. In other words, no thick color filter layer 109 exists between the liquid crystal layer 116 and the pixel electrode 110/common electrode 112. Hence, the required driving voltage for the LCD is lowered. In addition, without an organic color filter layer 109 above the pixel electrodes 110 and the common electrodes 112, no residual electric charges are trapped and hence quality of the LCD is improved.

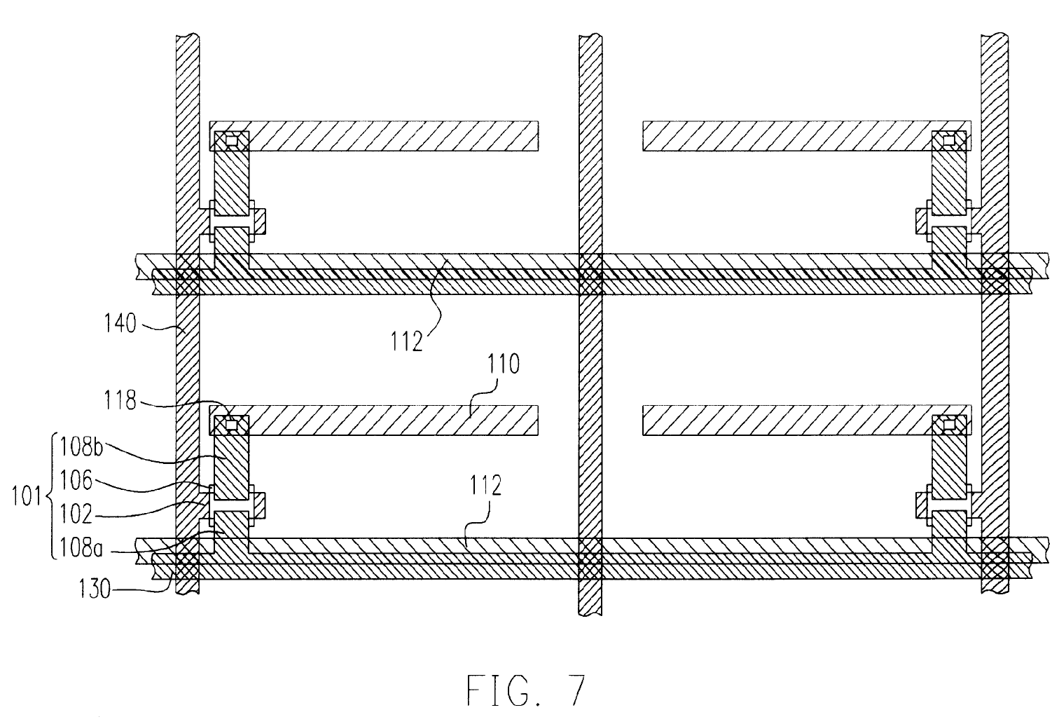

Moreover, the pixel electrodes 110 may also be positioned over the color filter layer 109 above the data lines 130 (as shown in FIG. 7) to increase the aperture ratio of the LCD. Since the color filter layer 109 has a sufficient thickness, the pixel electrodes 110 have no particular adverse effects on the data lines 130. Hence, this invention permits the placement of some pixel electrodes 110 over the color filter layer 109 above the data lines 130, thus boosting the aperture ratio of the LCD.

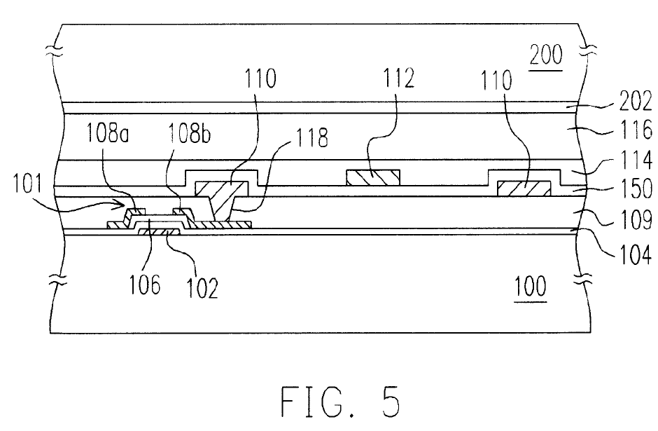

FIG. 2 is a top view showing the substrate having thin film transistors thereon of a wide viewing angle liquid crystal display according to one preferred embodiment of this invention. FIG. 5 is a cross-sectional view of one of the pixel regions in a FFS wide viewing angle LCD fabricated using the COA technique according to one preferred embodiment of this invention. To fabricate the wide viewing angle liquid crystal display, a first substrate 100 having a plurality of thin film transistors 101, a plurality of scanning lines 140 and a plurality of data lines 130 is provided.

To form the thin film transistors 101, the scanning lines 140 and the data lines 130 over the first substrate 100, gate electrodes 102 and scanning lines 140 connected to the gate electrode 102 are formed over the first substrate 100. Thereafter, an insulating material is deposited over the first substrate 100 to form a gate insulating layer 104 covering the gate electrodes 102 and the scanning lines 140. A channel layer 106 is formed over the gate insulating layer 104 above the gate electrode 102. A source/drain regions 108a/108b is formed over the channel layer 106. In the meantime, data lines 130 having connection with the respective source region 108a are formed over the gate insulating layer 104.

A color filter layer 109 is formed over the first substrate 100 covering the thin film transistors 101, the scanning lines 140 and the data lines 130. The color filter layer 109 comprises a plurality of red filter blocks (R), a plurality of green filter blocks (G) and a plurality of blue filter blocks (B) specifically arranged together to form groups. In this embodiment, the red (R), the green (G) and the blue (B) are arranged, for example, in mosaic type, triangle type, stripe type or four-pixel (RGGB) format. In addition, the network-like space between the R, G, B blocks is occupied by a black matrix (BM) layer.

A plurality of openings (not shown) that exposes the drain region 108b of the thin film transistors is formed in the color filter layer 109. A plurality of pixel electrodes 110 is formed over the color filter layer 109. In the meantime, electrode material is deposited into the openings to form a plurality of conductive structures 118. Each pixel electrode 110 is electrically connected to the drain region 108b of a corresponding thin film transistor 101 through the conductive structure 118. The method of forming the pixel electrodes 110 may include the following steps. First, an electrode material is deposited over the color filter layer 109 filling the openings to form an electrode layer. Thereafter, the electrode layer is patterned to form the pixel electrodes 110 so that the conductive structure 118 is also formed after the patterning process. Here, the pixel electrodes 110 are fabricated using, for example, a metallic material or an indium-tin-oxide (ITO) material.

Thereafter, a dielectric layer 150 is formed over the color filter layer 109. A common electrode 112 is formed over the dielectric layer 150. The common electrode 112 in each pixel region is serially linked to receive the same potential. Moreover, the pixel electrode 110 and the common electrode 112 in each pixel region are alternately positioned (as shown in FIG. 2). The common electrodes 112 are fabricated using, for example, a metallic material or an indium-tin-oxide (ITO) material. The pixel electrodes 110, the common electrodes 112 and the dielectric layer 150 between the pixel electrodes 110 and the common electrodes 112 together form a plurality of pixel storage capacitor structures.

A first alignment film 114 is formed over the dielectric layer 150 covering the common electrodes 112. The first alignment film 114 is a layer of material that aligns the subsequently deposited liquid crystal molecules in a designated direction.

Thereafter, as shown in FIG. 5, a second substrate 200 is provided. A second alignment film 202 is formed over the second substrate 200. Using a frame plastic (not shown), the second substrate 200 is fixed over the first substrate 100 such that the second alignment film 202 on the second substrate 200 faces the first alignment film 114 on the first substrate 100. Liquid crystal is injected into the space between the first alignment film 114 on the first substrate 100 and the second alignment film 202 on the second substrate 200 to form a crystal layer 116. Ultimately, a liquid crystal display is produced.

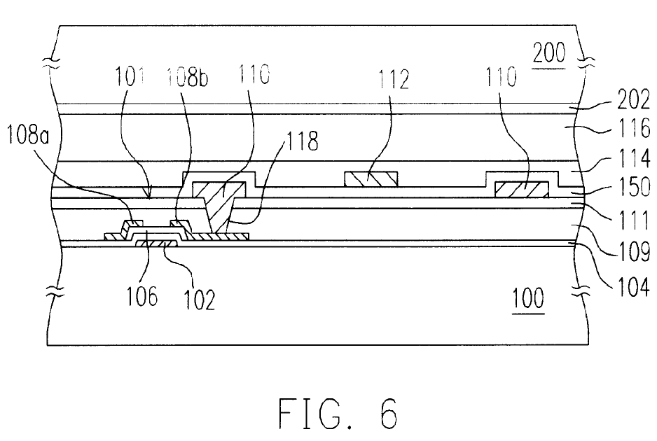

A planarization layer 111 (as shown in FIG. 6) may also be formed over the color filter layer 109. Since the surface between the R, G, B color regions and the black matrix layer in the color filter layer 109 is often uneven, the planarization layer 111 smoothes out the color filter layer 109.

This invention also provides a wide viewing angle LCD comprising a first substrate 100, a color filter layer 109, a plurality of pixel electrodes 110, a dielectric layer 150, a common electrode 112, a first alignment film 114, a second substrate 200, a second alignment film 202 and a liquid crystal layer 116. The surface of the first substrate 100 has a plurality of thin film transistors 101, a plurality of scanning lines 140 and a plurality of data lines 130. Each thin film transistor 101 has a gate electrode 102, a gate insulating layer 104, a channel layer 106 and source/drain regions 108a/108b. The color filter layer 109 is formed over the first substrate 100 covering the thin film transistor 101, the scanning lines 140 and the data lines 130. The pixel electrodes 110 are formed over a portion of the color filter layer 109. Each pixel electrode 110 and the drain region 108b of a corresponding thin film transistor 101 are electrically connected through a conductive structure 118 in the color filter layer 109. The dielectric layer 150 is formed over the color filter layer 109 covering the pixel electrodes 110. The common electrode 112 is formed over parts of the dielectric layer 150. The common electrode 112 and the pixel electrodes 110 are formed alternately and the common electrodes 112 in each pixel region are serially connected together to receive an identical potential. The pixel electrodes, the dielectric layer 150 and the common electrodes 112 together form a plurality of pixel storage capacitor structures. The first alignment film 114 is formed over the dielectric layer 150 covering the common electrodes 112. Furthermore, the second substrate 200 is fixed over the first substrate 100. The second alignment film 202 is formed over the surface of the second substrate 200 such that the second alignment film 202 faces the first alignment film 114 on the first substrate 100. The liquid crystal layer 116 is formed between the fist alignment film 114 and the second alignment film 202. A planarization layer 111 may also be selectively formed over the surface of the color filter layer 109.

In this invention, the color filter layer 109 is formed underneath the pixel electrodes 110 and the common electrodes 112. In other words, no thick color filter layer 109 exists between the liquid crystal layer 116 and the pixel electrode 110/common electrode 112. Hence, the required driving voltage for the LCD is lowered. In addition, without an organic color filter layer 109 above the pixel electrodes 110 and the common electrodes 112, no residual electric charges are trapped and hence quality of the LCD is improved.

Moreover, the pixel electrodes 110 may also be formed over the color filter layer 109 above the data lines 130 (as shown in FIG. 7) to increase the opening rate of the LCD. Since the color filter layer 109 has a sufficient thickness, the pixel electrodes 110 have no particular adverse effects on the data lines 130. Hence, this invention discloses the placement of some pixel electrodes 110 over the color filter layer 109 above the data lines 130, thus boosting the aperture ratioof the LCD.

In summary, major advantages of this invention include: 1. Since there is no thick color filter layer between the liquid crystal layer and the pixel electrode/common electrode, the required driving voltage for the wide viewing angle LCD is lowered. 2. Since there is no organic color filter layer above the pixel electrodes and the common electrode, no residual electric charges are trapped. Hence, the wide viewing angle LCD has an improved quality. 3. Since the pixel electrodes may also be formed over the scanning lines, aperture ratio of the LCD isincreased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A wide viewing angle liquid crystal display, comprising:
a first substrate having a plurality of thin film transistors, a plurality of scanning lines and a plurality of data lines;
a color filter layer over the first substrate covering the thin film transistors, the scanning lines and the data lines;
a plurality of pixel electrodes over parts of the color filter layer;
a plurality of common electrodes over parts of the color filter layer, wherein the common electrodes and the pixel electrodes are alternately positioned;
a first alignment film over the color filter layer covering the pixel electrodes and the common electrodes;
a second substrate formed above the first substrate;
a second alignment film formed over the second substrate, wherein the second alignment film faces the first alignment film; and
a liquid crystal layer formed between the first alignment film and the second alignment film.

2. The liquid crystal display of claim 1, wherein the display further includes a planarization layer over the color filter layer.

3. The liquid crystal display of claim 1, wherein the color filter layer includes a plurality of red-filter blocks, a plurality of green-filter blocks and a plurality of blue-filter blocks grouped together in a regular repetitive pattern.

4. The liquid crystal display of claim 3, wherein a black matrix layer is formed in the space between the red-filter blocks, the green-filter blocks and the blue-filter blocks.

5. The liquid crystal display of claim 1, wherein each thin film transistor includes:
a gate electrode above the first substrate, wherein the gate electrode is connected to a corresponding scanning line;
a gate insulating layer above the first substrate covering the gate electrode;
a channel layer over the gate insulating layer above the gate electrode; and
a source/drain regionsover the channel layer, wherein the source region is connected to a corresponding data line.

6. The liquid crystal display of claim 5, wherein the display further includes a conductive structure in the color filter layer for electrically connecting the drain region with a corresponding pixel electrode.

7. A wide viewing angle liquid crystal display, comprising:
a first substrate having a plurality of thin film transistors, a plurality of scanning lines and a plurality of data lines;
a color filter layer over the first substrate covering the thin film transistors, the scanning lines and the data lines;
a plurality of pixel electrodes over parts of the color filter layer;
a dielectric layer over the color filter layer covering the pixel electrodes;
a plurality of common electrode over parts of the color filter layer, wherein the common electrodes and the pixel electrodes are alternately positioned;
a first alignment film over the dielectric layer covering the common electrodes;
a second substrate formed above the first substrate;
a second alignment film formed above the second substrate, wherein the second alignment film faces the first alignment film; and
a liquid crystal layer formed between the first alignment film and the second alignment film.

8. The liquid crystal display of claim 7, wherein the display further includes a planarization layer over the color filter layer.

9. The liquid crystal display of claim 7, wherein the pixel electrodes, the common electrodes and the dielectric layer together form a plurality of pixel storage capacitors.

10. The liquid crystal display of claim 7, wherein the color filter layer includes a plurality of red-filter blocks, a plurality of green-filter blocks and a plurality of blue-filter blocks grouped together in a regular repetitive pattern.

11. The liquid crystal display of claim 10, wherein a black matrix layer is formed in the space between the red-filter blocks, the green-filter blocks and the blue-filter blocks.

12. The liquid crystal display of claim 7, wherein each thin film transistor includes:
a gate electrode above the first substrate, wherein the gate electrode is connected to a corresponding scanning line;
a gate insulating layer above the first substrate covering the gate electrode;
a channel layer over the gate insulating layer above the gate electrode; and
a source/drain regionsover the channel layer, wherein the source region is connected to a corresponding data line.

13. The liquid crystal display of claim 12, wherein the display further includes a conductive structure in the color filter layer for electrically connecting the drain region with a corresponding pixel electrode.

14. A method of manufacturing a wide viewing angle liquid crystal display, comprising the steps of:
providing a first substrate having a plurality of thin film transistors, a plurality of scanning lines and a plurality of data lines;
forming a color filter layer over the first substrate to cover the thin film transistors, the scanning lines and the data lines;
forming a plurality of pixel electrodes and a plurality of common electrodes over the color filter layer, wherein the pixel electrodes and the common electrodes are alternately positioned;
forming a first alignment film over the color filterto cover the pixel electrodes and the common electrodes;
providing a second substrate;
forming a second alignment film over the second substrate;
forming the second substrate above the first substrate such that the second alignment film faces the first alignment film; and
injecting liquid crystal into the space between the first alignment film and the second alignment film to form a liquid crystal layer.

15. The method of claim 14, wherein after the step of forming the color filter layer, further includes forming a planarization layer over the color filter layer.

16. The method of claim 14, wherein the color filter layer includes a plurality of red-filter blocks, a plurality of green-filter blocks and a plurality of blue-filter blocks grouped together in a regular repetitive pattern.

17. The method of claim 16, wherein a black matrix layer is formed in the space between the red-filter blocks, the green-filter blocks and the blue-filter blocks.

18. The method of claim 14, wherein in the step of providing the first substrate having a plurality of thin film transistors, the thin film transistors are formed by the steps comprising:
forming a gate electrode and a plurality of scanning lines connected to the gate electrode over the first substrate;
forming a gate insulating layer over the first substrate to cover the gate electrode and the scanning lines;
forming a channel layer over the gate insulating layer above the gate; and
forming source/drain regions and the data linesto connect with the drain region.

19. The method of claim 18, further comprising forming a conductive structure in the color filter layer for electrically connecting the drain region with a corresponding pixel electrode.
